(19) United States
(12) Patent Application Publication
(10) Pub. No.: US 2017/0351691 A1
(43) Pub. Date: Dec. 7, 2017

(54) SEARCH METHOD AND APPARATUS

(71) Applicant: BEIJING QIHOO TECHNOLOGY COMPANY LIMITED, Beijing (CN)

(72) Inventors: Bin LI, Beijing (CN); Yanbei JIANG, Beijing (CN); Shaoqing TAN, Beijing (CN)

(21) Appl. No.: 15/541,009

(22) PCT Filed: Nov. 3, 2015
(86) PCT No.: PCT/CN2015/093720

§ 371 Date: Jun. 29, 2017

(30) Foreign Application Priority Data
Dec. 29, 2014 (CN) 201410849741.7

(51) Int. Cl. G06F 17/30; H04M 7/00

(52) U.S. Cl. CPC G06F 17/3087; H04M 7/003; G06F 17/3051; G06F 17/3053; G06F 17/30554

(57) ABSTRACT

The present invention discloses a search method and apparatus, wherein the method comprises: receiving, at a browser side, a search keyword inputted to an input box component; obtaining a search result corresponding to the search keyword, the search result comprising feature information carrying a feature identifier; and displaying the search result, wherein the feature information carrying a feature identifier is ranked first in the search result. The present invention may obtain accurate key information from the feature information carrying a feature identifier, and avoid a situation where bandwidth resources are consumed because of repeatedly searching for correct feature information due to the feature information being erroneous. Thus user operations are simplified and search efficiency is improved.

### CROSS-REFERENCE TO RELATED APPLICATIONS

This application is the national stage of International Application No. PCT/CN2015/093720 filed Nov. 3, 2015, which claims the benefit of Chinese Patent Applications No. CN201410849741.7, filed Dec. 29, 2014, the entirety of which are incorporated herein by reference.

### FIELD OF TECHNOLOGY

The present invention relates to the field of search technologies, and more particularly, to a search method and a search apparatus.

### BACKGROUND

With the rapid development of the Internet, more and more information is provided on the Internet. To acquire desired information on the Internet, searching information by a search engine using a webpage browser becomes the most common behavior of an Internet user.

When performing searching, the user may input keywords in an address bar of the browser or a search box of the search engine, and then clicks to acquire search results. Generally, a principle of ranking the search results on a webpage presenting the search results is as follows: a correlation, from large to small, between the search results and the search keywords corresponds to a search result ranking sequence from up to down (or from front to back). However, these search results related to the user's intention do not show correct key information of the page corresponding to the search results, or key information desired by the user is not ranked first. For example, when the user wants to inquire a telephone number of a certain merchant, the search result including the telephone number is not necessarily ranked first, so that the user needs to spend time searching the telephone number. Furthermore, the telephone number is not necessarily a correct telephone number, and the user needs to search the correct telephone number again when finding that the telephone number is not the desired telephone number after dialing, which consumes bandwidth resources.

### SUMMARY

In view of the above problems, the present invention is proposed to provide a search method and a corresponding search apparatus to overcome or at least partially solve or mitigate the above problems.

According to an aspect of the present invention, there is provided a search method, which includes:

receiving, at a browser side, a search keyword inputted to an input box component;

obtaining a search result corresponding to the search keyword, the search result comprising feature information carrying a feature identifier; and

displaying the search result, wherein the feature information carrying a feature identifier is ranked first in the search result.

Optionally, the feature information carrying a feature identifier has portal information of a preassociated webpage type service, and the method further comprises:

displaying a service page corresponding to the portal information when receiving a trigger operation for the feature information.

Optionally, the feature information carrying a feature identifier is merchant information having a promotion identifier.

Optionally, the step of obtaining a search result corresponding to the search keyword comprises:

searching for the search result corresponding to the search keyword from a local database of the browser, and executing the step of displaying the search result when the search result comprises the feature information carrying a feature identifier.

Optionally, the step of obtaining a search result corresponding to the search keyword further comprises:

generating a search request in accordance with the search keyword and submitting the search request to a server when the search result in the local database does not comprise the feature information carrying a feature identifier; and

receiving the feature information carrying a feature identifier, returned by the server, corresponding to the search request, wherein the feature information returned by the server is obtained by searching the search keyword out from a database of the server after the server has received the search request.

Optionally, the feature information comprises a telephone number, the local database is a local contact list corresponding to a contact list application of a terminal device where the browser is; and the database of the server is a contact list of a server side corresponding to the contact list application of the terminal device where the browser is, wherein one or more telephone numbers carrying a feature identifier are stored in the local contact list and or the contact list of a server side.

Optionally, the feature information comprises a telephone number, and the method further includes:

saving the telephone number carrying a feature identifier in a contact list application.

Optionally, the method further includes:

receiving a push message sent by a webpage type service corresponding to the telephone number carrying a feature identifier.

Optionally, the feature information comprises a telephone number, and the method further includes:

generating a dialing command when detecting a click operation for the telephone number, and sending the dialing command to a server, so that the server initiates a voice call request based on the telephone number to a communication operator in accordance with the dialing command;

and/or

displaying a message editing page when detecting the click operation for the telephone number, and sending a communication message to a terminal device corresponding to the telephone number when detecting the communication message inputted for the message editing page.

Optionally, the method further includes:

when receiving dialing failure information returned by the server, invoking the portal information of the webpage type service based on the dialing failure information, and displaying a corresponding webpage type service page.

Optionally, the step of obtaining a search result corresponding to the search keyword includes:

obtaining current location information of a user; and

obtaining, based on the current location information, the search result corresponding to the search keyword and associated with the current location information.

According to another aspect of the present invention, there is provided a search apparatus, which includes:

a keyword receiving module, configured to receive, at a browser side, a search keyword inputted to an input box component;

a search result acquiring module, configured to obtain a search result corresponding to the search keyword, the search result comprising feature information carrying a feature identifier; and a search result displaying module, configured to display the search result, wherein the feature information carrying a feature identifier is ranked first in the search result.

Optionally, the feature information carrying a feature identifier has portal information of a preassociated webpage type service, and the apparatus further includes:

a page displaying module, configured to display a service page corresponding to the portal information when receiving a trigger operation for the feature information.

Optionally, the feature information carrying a feature identifier is merchant information having a promotion identifier.

Optionally, the search result acquiring module is further configured to:

search for the search result corresponding to the search keyword from a local database of the browser, and execute the step of displaying the search result when the search result comprises the feature information carrying a feature identifier.

Optionally, the search result acquiring module is further configured to:

generate a search request in accordance with the search keyword and submit the search request to a server when the search result in the local database does not comprise the feature information carrying a feature identifier; and

receive the feature information carrying a feature identifier, returned by the server, corresponding to the search request, wherein the feature information returned by the server is obtained by searching the search keyword out from a database of the server after the server has received the search request.

Optionally, the feature information comprises a telephone number, the local database is a local contact list corresponding to a contact list application of a terminal device where the browser is; and the database of the server is a contact list of a server side corresponding to the contact list application of the terminal device where the browser is, wherein one or more telephone numbers carrying a feature identifier are stored in the local contact list and or the contact list of a server side.

Optionally, the feature information comprises a telephone number, and the apparatus further comprises:

an information saving module, configured to save the telephone number carrying a feature identifier in a contact list application.

Optionally, the apparatus further includes:

a push message receiving module, configured to receive a push message sent by a webpage type service corresponding to the telephone number carrying a feature identifier.

Optionally, the feature information comprises a telephone number, and the apparatus further includes:

a calling module, configured to generate a dialing command when detecting a click operation for the telephone number, and send the dialing command to a server, so that the server initiates a voice call request based on the telephone number to a communication operator in accordance with the dialing command; and

a short message sending module, configured to display a message editing page when detecting the click operation for the telephone number, and send a communication message to a terminal device corresponding to the telephone number when detecting the communication message inputted for the message editing page.

Optionally, the apparatus further includes:

a displaying module, configured to invoke, when receiving dialing failure information returned by the server, the portal information of the webpage type service based on the dialing failure information, and display a corresponding webpage type service page.

Optionally, the search result acquiring module is further configured to:

obtain current location information of a user; and

obtain, based on the current location information, the search result corresponding to the search keyword and associated with the current location information.

According to still another aspect of the present invention, there is provided a computer program, which includes a computer-readable code, wherein when the computer-readable code runs on an electronic device, the electronic device is caused to execute the search method.

According to still another aspect of the present invention, there is provided a computer-readable medium, in which the computer program is stored.

The present invention has the beneficial effects that in the embodiments of the present invention, after a browser receives a search keyword, a search result including feature information carrying a feature identifier that corresponds to the search keyword is acquired. When the search result is displayed, the feature information carrying a feature identifier that best meets the search intention of the user is ranked first in the search result so that the user acquires the desired information at first time. Furthermore, the feature information carrying a feature identifier has correct key information of the search result. Therefore, the user may obtain correct key information from the feature information carrying a feature identifier, thereby avoiding a case where bandwidth resource is consumed resulting from repeatedly searching correct feature information due to wrong feature information, simplifying operation of the user and improving search efficiency.

In addition, the feature information carrying a feature identifier has portal information of preassociated webpage type services. By clicking the portal information on the search result page, a corresponding service page may be entered, and the user may select a corresponding service on the service page. In this way, the user may precisely locate to the service page according to the search results, thereby saving search time for the user. Furthermore, the user does not need to repeatedly search for the service pages, thereby saving the bandwidth resources.

Described above is merely an overview of a technical solution of the present invention. In order to more apparently understand the technical means of the present invention to implement in accordance with the contents of specification, and to more readily understand above and other objectives, features and advantages of the present invention, specific embodiments of the present invention are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the present invention. Further, throughout the drawings, same elements are indicated by same reference numbers. In the drawings:

FIG. 1 schematically illustrates a step flowchart of a search method Embodiment I according to an embodiment of the present invention;

FIG. 2 schematically illustrates a step flowchart of a search method Embodiment II according to an embodiment of the present invention;

FIG. 3 schematically illustrates a schematic diagram of a service page of a search method Embodiment II according to an embodiment of the present invention;

FIG. 4 schematically illustrates a step flowchart of a search method Embodiment III according to an embodiment of the present invention;

FIG. 5 schematically illustrates a structural block diagram of a search apparatus embodiment according to an embodiment of the present invention;

FIG. 6 schematically illustrates a block diagram of an electronic device for performing the method according to the present invention; and

FIG. 7 schematically shows a storage unit for maintaining or carrying a program code for implementing the method according to the present invention.

### DESCRIPTION OF THE EMBODIMENTS

A further description of the present invention is made with reference to the accompanying drawings and specific embodiments hereinafter.

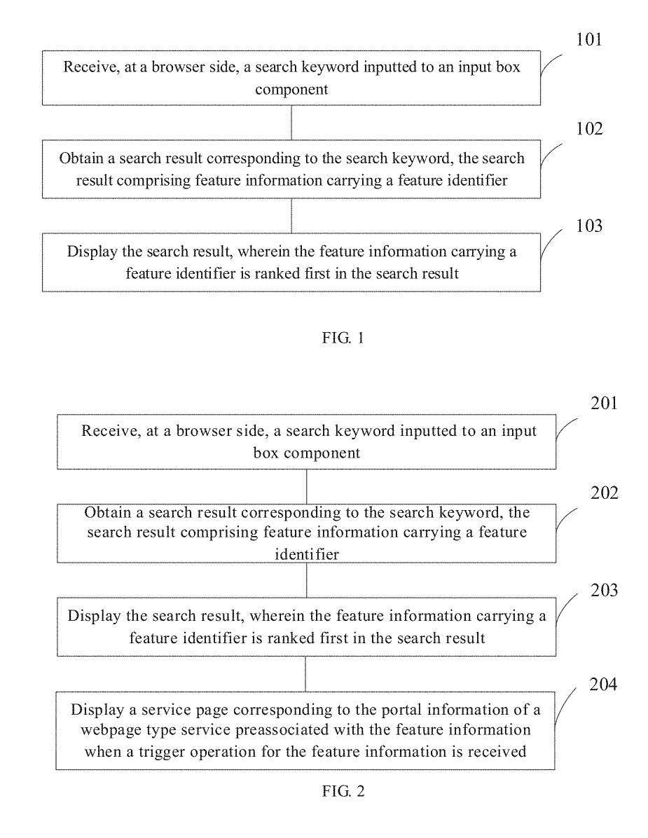

Referring to FIG. 1, which illustrates a step flowchart of a search method embodiment I according to an embodiment of the present invention, the method may include following steps:

Step 101: receiving, at a browser side, a search keyword inputted to an input box component;

Step 102: obtaining a search result corresponding to the search keyword, the search result comprising feature information carrying a feature identifier; and

Step 103: displaying the search result, wherein the feature information carrying a feature identifier is ranked first in the search result.

In the embodiments of the present invention, after the browser receives a search keyword, a search result including feature information carrying a feature identifier that corresponds to the search keyword is obtained. When the search result is displayed, the feature information carrying a feature identifier that best meets the search intention of the user is ranked first in the search result so that the user obtains the desired information at first time. Furthermore, the feature information carrying a feature identifier has correct key information of the search result. Therefore, the user may obtain correct key information from the feature information carrying a feature identifier, thereby avoiding a case where bandwidth resource is consumed resulting from repeatedly searching correct feature information due to wrong feature information, simplifying operation of the user and improving search efficiency.

Referring to FIG. 2, which illustrates a step flowchart of a search method embodiment II according to an embodiment of the present invention, the method may include following steps.

Step 201: receiving, at a browser side, a search keyword inputted to an input box component.

This embodiment of the present invention may be applied to a mobile device. The input box component may be a control, in the browser, that can receive information inputted by the user, such as an address bar of the browser, or a search box corresponding to the search engine in a browser page.

The search keywords inputted by the user in the input box component of the browser may include a telephone number, or a character string related to a business name correlated to the telephone number. For example, when the user wants to search information of a certain merchant, the search keyword inputted by the user may be the telephone number of the merchant, or information related to the business name of the merchant, such as a name, an address or a sold product of the merchant.

Step 202: obtaining a search result corresponding to the search keyword, the search result comprising feature information carrying a feature identifier.

After receiving the search keyword, the browser may obtain the search result corresponding to the search keyword, wherein the search result may include a search result including the feature information carrying a feature identifier. As a preferred example of this embodiment, the feature information may be merchant information, such as a merchant name, a merchant telephone number and a merchant address, and the feature identifier may be promotion identifier of the merchant. For example, the merchant telephone number carrying the promotion identifier may be represented as below: 12345 (shop), wherein the (shop) is the promotion identifier, and the 12345 is the telephone number.

The browser may obtain the search result corresponding to the search keyword locally and/or from the server. In a preferred embodiment of the present invention, Step 202 may include the following substeps.

Substep S11: searching for the search result corresponding to the search keyword from a local database of the browser.

To increase the search efficiency, reduce search stress of the server, reduce the number of times of interaction between the browser and the server and save the network resources, in this embodiment of the present invention, after receiving the search keyword, the browser may first match the search keyword in the local database of the browser to obtain the corresponding search result.

The local database of the browser may be a local database of a terminal device where the browser is. The local database may save cached data of the browser (including browsing history of the browser) and save local data, of other applications in the terminal device, in the terminal device.

When the browser wants to obtain the local data of other applications in the terminal device, the browser may invoke relevant interfaces of the applications to obtain the local data.

Substep S12: determining whether the search result includes the feature information carrying a feature identifier, and executing Step 203 when the determination result is yes; otherwise executing Substep S13.

After obtaining a local search result based on a local search, the browser may check whether the search result includes the search result including the feature information carrying a feature identifier. For example, the browser may check whether the search result includes the search result including merchant information carrying a promotion identifier.

Substep S13: generating a search request in accordance with the search keyword and submitting the search request to a server, and receiving the feature information carrying a feature identifier, returned by the server, corresponding to the search request.

When the browser determines that the local search result does not comprise the search result including the feature information carrying a feature identifier, the browser may further generate a search request in accordance with the search keyword and send the search request to the server corresponding to the browser. After receiving the search request, the server searches a search result matching the search keyword from a database at the server side. When the search result matched by the server comprises the search result including the feature information carrying a feature identifier, the search result including the feature information carrying a feature identifier is returned to the browser.

Of course, after receiving the search keyword, the browser may also directly execute Substep S13 without the local search process in Substep S11 and Substep S12, which is not limited by the embodiments of the present invention.

Step 203: displaying the search result, wherein the feature information carrying a feature identifier is ranked first in the search result.

Applied to the embodiments of the present invention, after the browser obtains the search result including the feature information, the search result is displayed in a browser interface, wherein the feature information carrying a feature identifier is ranked first in the search result.

It is to be noted that in the embodiments of the present invention, the search based on the search keyword may be an instant search, also known as instantaneous search, which is a search technology based on emerging technologies such as RSS/ATOM or TAG for providing a user with a search result close to a real-time effect. As the user inputs the search keyword into the input box component, the instant search may instantly provide the search results and search suggestions in the input box component according to the inputted search keyword, and may automatically complement a search suggestion ranking first. As the user continues inputting new search keywords, both the provided search suggestions and the refreshed search result pages may vary concurrently to achieve an effect of displaying while searching.

Further, in concrete implementation, in the process of instant search, a search result associated with user current location information may be displayed in priority in accordance with the user current location information, serving as a search factor, obtained by the browser. For example, when the feature information carrying a feature identifier is displayed, the feature information carrying a feature identifier associated with the user current location information may be displayed in priority when there are multiple pieces of feature information. For example, when the feature information carrying a feature identifier is two telephone numbers of merchant A, which are respectively as follows: merchant A: 12345-1 (shop) (a telephone number of the merchant A in a region A) and merchant A: 12345-2 (shop) (a telephone number of the merchant A in a region B). When the current location of the user is a location A after search, the search record “merchant A: 12345-1 (shop)” is ranked first in the search result display page.

Step 204: displaying a service page corresponding to the portal information of a webpage type service preassociated with the feature information when a trigger operation for the feature information is received.

Applied to this embodiment of the present invention, the feature information carrying a feature identifier in the search result also has portal information of a preassociated webpage type service. As an example of this embodiment, the portal information may be a URL of a webpage type service. The webpage type service may be an online service for processing e-commerce information by an entity corresponding to the feature information. For example, when the entity corresponding to the feature information is a merchant, the online service of the merchant may be a food ordering service, a ticket-booking service, a phone recharging service, etc.

In the search result display page, when the user triggers the feature information carrying a feature identifier (for example, clicking or selecting the feature information), the portal information of the webpage type service corresponding to the feature information may be invoked, and then the corresponding service page is displayed. For example, the service page may be a food ordering service page.

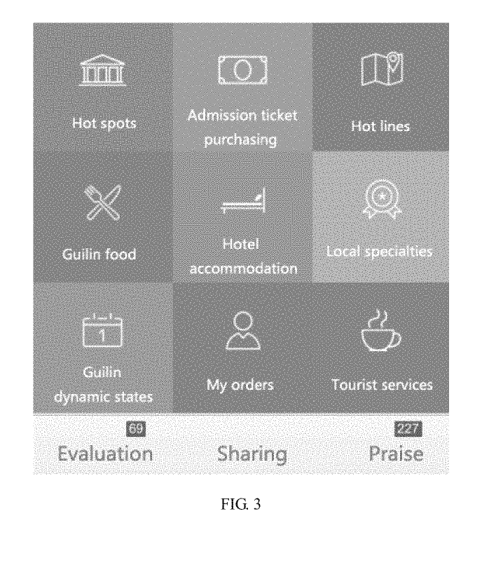

In practice, the service page is a page which is customized by a subject (such as the merchant) of the feature information in advance and related to business thereof. The service page includes various types of business services, as shown in FIG. 3, the service page in FIG. 3 is a service page of a certain scenery spot, which may include multiple services such as hot spots, admission ticket purchasing, hot lines, food, hotel accommodation, local specialties, dynamic states, my orders and tourist services. The user may select one relevant service when entering the service page.

It is to be noted that to enhance the user experience and avoid consuming page resources due to the user repeatedly refreshing the page, when displaying the service page, also the service page associated with the user current location information may be first displayed.

In this embodiment of the present invention, after the browser receives a search keyword, a search result including feature information carrying a feature identifier that corresponds to the search keyword is acquired. When the search result is displayed, the feature information is ranked first in the search result. The feature information carrying a feature identifier has portal information of preassociated webpage type services. By clicking the portal information on the search result page, a corresponding service page may be entered, and the user may select a corresponding service on the service page. In this way, the user may precisely locate to the service page according to the search result, thereby saving search time for the user. Furthermore, the user does not need to repeatedly search for the service page, thereby saving the bandwidth resources.

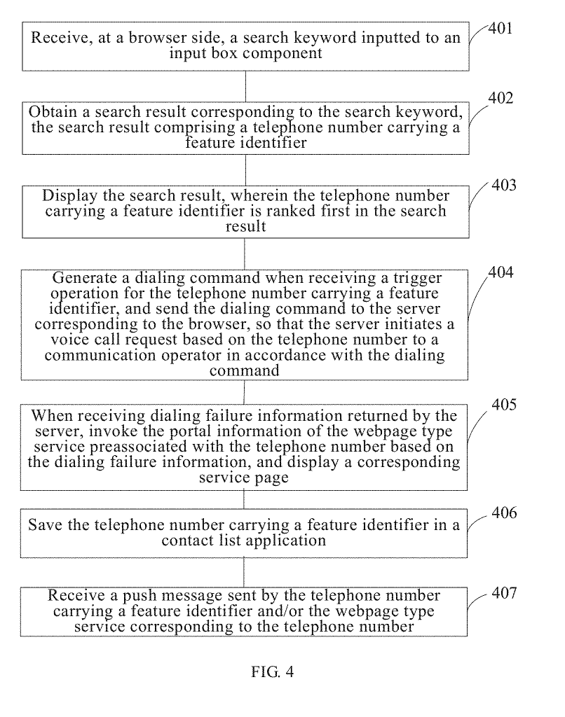

Referring to FIG. 4, which illustrates a step flowchart of a search method Embodiment III according to an embodiment of the present invention, the method may include following steps.

Step 401: receiving, at a browser side, a search keyword inputted to an input box component.

This embodiment of the present invention may be applied to a mobile device. The input box component may be a control, in the browser, that can receive information inputted by the user, such as an address bar of the browser, or a search box corresponding to the search engine in a browser page.

The search keyword inputted by the user in the input box component of the browser may include a telephone number, or a character string related to a business name correlated to the telephone number, and by searching the character string, a search result including the telephone number may be obtained. For example, when the user wants to search information of a certain merchant, the search keyword inputted by the user may be the telephone number of the merchant, or the name, the address or a sold product of the merchant.

Step 402: obtaining a search result corresponding to the search keyword, the search result comprising a telephone number carrying a feature identifier.

After receiving the search keyword, the browser may obtain the search result corresponding to the search keyword, wherein the search result may include a search result including the telephone number carrying a feature identifier. As a preferred example of this embodiment, the feature information may be a promotion identifier of the merchant. For example, the merchant telephone number carrying the promotion identifier may be represented as below: 12345 (shop), wherein the (shop) is the promotion identifier, and the 12345 is the telephone number.

The browser may obtain the search result corresponding to the search keyword locally and/or from the server. In a preferred embodiment of the present invention, Step 402 may include the following substeps.

Substep S21: searching for the search result corresponding to the search keyword from a local contact list of the browser.

To increase the search efficiency, reduce search stress of the server, reduce the number of times of interaction between the browser and the server and save the network resources, in this embodiment of the present invention, after receiving the search keyword, the browser may first match the search keyword in the local contact list of a terminal device where the browser is to obtain the corresponding search result. The local contact list may be a local contact list of a contact list application installed in the terminal device, and the local contact list stores one or more telephone numbers carrying feature identifiers.

Substep S22: determining whether the search result includes the telephone number carrying a feature identifier, and executing Step 403 when the determination result is yes, otherwise executing Substep S23.

After obtaining a local search result based on the search of the local contact list, the browser may check whether the search result includes the search result including the telephone number carrying a feature identifier.

Substep S23: generating a search request in accordance with the search keyword and submitting the search request to a server, and receiving the telephone number carrying a feature identifier, returned by the server, corresponding to the search request.

When the browser determines that the local search result does not comprise the search result including the telephone number carrying a feature identifier, the browser may further generate a search request in accordance with the search keyword and send the search request to the server. The server is a server corresponding to the contact list application. In practice, the browser may send the search request to the server corresponding to the browser. After receiving the search request, the server corresponding to the browser invokes an interface of the server of the contact list application to forward the search request to the server corresponding to the contact list application.

After receiving the search request, the server corresponding to the contact list application searches a search result matching the search keyword from a contact list at the server side. When the search result matched by the server comprises the search result including the telephone number carrying a feature identifier, the search result including the telephone number carrying a feature identifier is returned to the server corresponding to the browser, which forwards the search result to the browser. The contact list at the contact list application server side stores one or more telephone numbers carrying feature identifiers.

Of course, after receiving the search keyword, the browser may also directly execute Substep S23 without the local search process in Substep S21 and Substep S22, which is not limited by the embodiment of the present invention.

Step 403: displaying the search result, wherein the telephone number carrying a feature identifier is ranked first in the search result.

Applied to this embodiment of the present invention, after the browser obtains the search result including the telephone number carrying a feature identifier, the search result is displayed in a browser interface, wherein the telephone number carrying a feature identifier is ranked first in the search result.

It is to be noted that in concrete implementation, the search in this embodiment of the present invention is an instant search. In the process of the instant search, a search result associated with user current location information may be displayed in priority in accordance with the user current location information, serving as a search factor, obtained by the browser. Further, when the telephone number carrying a feature identifier is displayed, the telephone number carrying a feature identifier associated with the user current location information may be displayed in priority when there are a plurality of telephone numbers conforming to the requirements.

Step 404: generating a dialing command when receiving a trigger operation for the telephone number carrying a feature identifier, and sending the dialing command to the server corresponding to the browser, so that the server initiates a voice call request based on the telephone number to a communication operator in accordance with the dialing command.

Applied to this embodiment of the present invention, in the search page, the browser may generate a dialing command when detecting the trigger operation (such as click operation) for the telephone number carrying a feature identifier, and send the dialing command to the server corresponding to the browser, so that the server initiates a voice call request based on the telephone number to a communication operator in accordance with the dialing command.

Step 405: when receiving dialing failure information returned by the server, invoking the portal information of the webpage type service preassociated with the telephone number based on the dialing failure information, and displaying a corresponding service page.

When the server corresponding to the browser does not receive a response message from the communication operator within a preset period of time or receives a response failure message returned by the communication operator, the server generates dialing failure information and returns the dialing failure information to the browser to inform the browser of failure in dialing the telephone number. After receiving the dialing failure information, the browser invokes the portal information of the webpage type service corresponding to the telephone number.

Specifically, applied to this embodiment of the present invention, the telephone number carrying a feature identifier in the search result also has the portal information of a preassociated webpage type service. As an example of this embodiment, the portal information may be a URL of a webpage type service. The webpage type service may be an online service for processing e-commerce information by an entity corresponding to the feature information. For example, when the entity corresponding to the feature information is a merchant, the online service of the merchant may be a food ordering service, a ticket-booking service, a phone recharging service, etc.

After invoking the portal information of the webpage type service corresponding to the telephone number, the browser may display a corresponding service page. For example, the service page may be a food ordering service page.

In practice, the service page is a page which is customized by a subject (such as the merchant) of the feature information in advance and related to business thereof. When entering the service page, the user may select a correlated service to complete the corresponding service operation, such as food ordering or phone recharging.

It is to be noted that to enhance the user experience and avoid consuming page resources due to the user repeatedly refreshing the page, when displaying the service page, also the service page associated with the user current location information may be first displayed.

Step 406: saving the telephone number carrying a feature identifier in a contact list application.

After obtaining the search result including the telephone number carrying a feature identifier, the browser may save the telephone number carrying a feature identifier in the contact list application. Specifically, in an implementation, when the browser receives the telephone number carrying a feature identifier, returned by the server, corresponding to the search request, the browser creates a contact directory in the local contact list by invoking an interface of the contact list application, and saves the telephone number carrying a feature identifier under the created contact directory.

In practice, in addition to the telephone number carrying a feature identifier, the created contact directory may further include the portal information of the webpage type service associated with the telephone number, and the subject name of the telephone number, for example, the merchant name.

It is to be noted that this embodiment of the present invention does not strictly limit execution sequences of Step 405 and Step 406. Step 405 and Step 406 may be simultaneously executed, or Step 405 may be executed before or after Step 406.

Step 407: receiving a push message sent by the telephone number carrying a feature identifier and/or the webpage type service corresponding to the telephone number.

After the browser saves the telephone number carrying a feature identifier in the local contact list (this may be understood that the browser has followed the telephone number), the browser may receive the push message sent by the webpage type service corresponding to the telephone number, for example, pushed advertising information.

It is to be noted that this embodiment of the present invention is not limited to generating a dialing command when the trigger operation for the telephone number carrying a feature identifier is received, other operation also may be allowed, for example, displaying a message editing page, and sending a communication message to a terminal device corresponding to the telephone number when detecting the communication message inputted for the message editing page. Specifically, the browser sends the communication message to the server corresponding to the browser, then the server sends the communication message to a communication operator, and then the communication operator sends the communication message to the terminal device corresponding to the telephone number.

In this embodiment of the present invention, after receiving the search keyword, the browser obtains the search result, including the telephone number carrying a feature identifier, corresponding to the search keyword, and ranks the telephone number first in the search result when the search result is displayed so that the user may obtain the desired telephone number at first time. The telephone number carrying a feature identifier has portal information of a preassociated webpage type service. When the telephone number is clicked, the telephone number may be directly dialed. When dialing the telephone number fails, the service page corresponding to the portal information is directly entered to continue providing service for the user. Therefore, the user may directly obtain the desired telephone number from the search result and directly dial the telephone number, thereby saving time in searching for the telephone number and manually inputting the telephone number for the user, and simplifying the user operation. Furthermore, it is unnecessary for the user to repeatedly search for the telephone number, thereby saving bandwidth resources.

It should be explained that, for a brief description, method embodiments are described as a combination of a series of motions. However, those skilled in the art should know that the present invention is not limited by sequences of the motions described. This is because some steps may be performed by using other sequences or be performed simultaneously in accordance with the present invention. In addition, those skilled in the art should also learn that the embodiments described in the specification are preferred embodiments, and involved motions and modules are not necessary for the present invention.

Referring to FIG. 5, which illustrates a structural block diagram of a search apparatus embodiment according to an embodiment of the present invention, the search apparatus may include following modules:

a keyword receiving module 501, configured to receive, at a browser side, a search keyword inputted to an input box component;

a search result acquiring module 502, configured to obtain a search result corresponding to the search keyword, the search result comprising feature information carrying a feature identifier; and

a search result displaying module 503, configured to display the search result, wherein the feature information carrying a feature identifier is ranked first in the search result.

In a preferred embodiment of the present invention, the feature information carrying a feature identifier has portal information of a preassociated webpage type service, and the apparatus further includes:

a page displaying module, configured to display a service page corresponding to the portal information when receiving a trigger operation for the feature information.

As a preferred example of the embodiment of the present invention, the feature information carrying a feature identifier is merchant information having a promotion identifier.

In a preferred embodiment of the present invention, the search result acquiring module 502 is further configured to:

search for the search result corresponding to the search keyword from a local database of the browser, and execute the step of displaying the search result when the search result comprises the feature information carrying a feature identifier.

In a preferred embodiment of the present invention, the search result acquiring module 502 is further configured to:

generate a search request in accordance with the search keyword and submit the search request to a server when the search result in the local database does not comprise the feature information carrying a feature identifier; and

receive the feature information carrying a feature identifier, returned by the server, corresponding to the search request, wherein the feature information returned by the server is obtained by searching the search keyword out from a database of the server after the server has received the search request.

In a preferred embodiment of the present invention, the feature information comprises a telephone number, the local database is a local contact list corresponding to a contact list application of a terminal device where the browser is; and the database of the server is a contact list of a server side corresponding to the contact list application of the terminal device where the browser is, wherein one or more telephone numbers carrying a feature identifier are stored in the local contact list and or the contact list of a server side.

In a preferred embodiment of the present invention, the feature information comprises a telephone number, and the apparatus further includes:

an information saving module, configured to save the telephone number carrying a feature identifier in a contact list application.

In a preferred embodiment of the present invention, the apparatus further includes:

a push message receiving module, configured to receive a push message sent by a webpage type service corresponding to the telephone number carrying a feature identifier.

In a preferred embodiment of the present invention, the feature information comprises a telephone number, and the apparatus further includes:

a calling module, configured to generate a dialing command when detecting a click operation for the telephone number, and send the dialing command to a server, so that the server initiates a voice call request based on the telephone number to a communication operator in accordance with the dialing command; and

a short message sending module, configured to display a message editing page when detecting the click operation for the telephone number, and send a communication message to a terminal device corresponding to the telephone number when detecting the communication message inputted for the message editing page.

In a preferred embodiment of the present invention, the apparatus further includes:

a displaying module, configured to invoke, when receiving dialing failure information returned by the server, the portal information of the webpage type service based on the dialing failure information, and display a corresponding webpage type service page.

In a preferred embodiment of the present invention, the search result acquiring module 502 is further configured to:

obtain current location information of a user; and

obtain, based on the current location information, the search result corresponding to the search keyword and associated with the current location information.

Apparatus embodiments in FIG. 5 are basically similar to the above method embodiments, so description of the apparatus embodiments is relatively simple. Reference is made to the method embodiments which may serve as reference.

The embodiments in the specification are described in a progressive manner. Each embodiment is focused on difference from other embodiments. And cross reference is available for identical or similar parts among different embodiments.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the search apparatus according to the embodiments of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

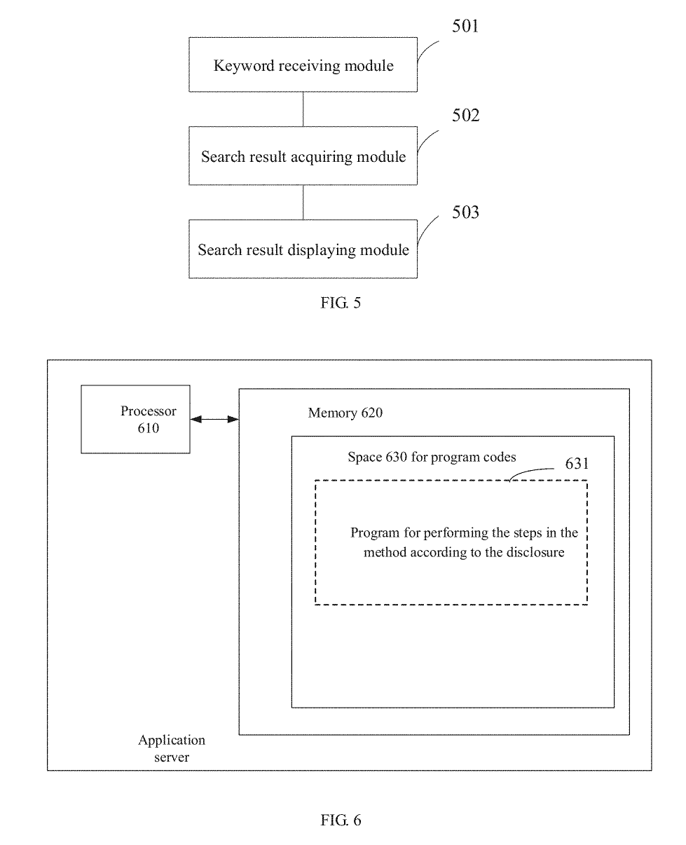

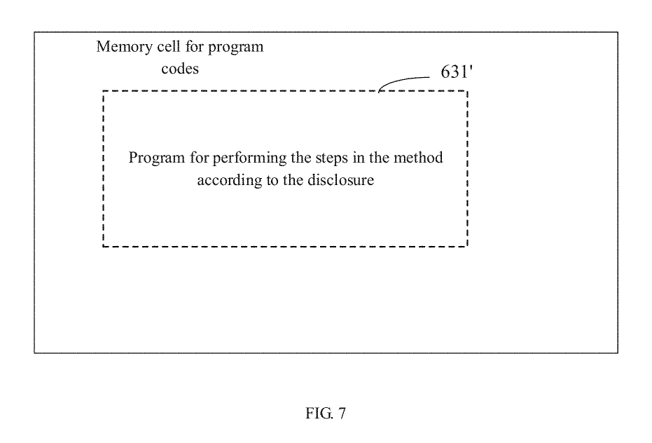

For example, FIG. 6 illustrates an electronic device that may implement information loading based on a telephone number according to the present invention, for example, an application server. Traditionally, the server includes a processor 610 and a computer program product or a computer readable medium in form of a memory 620. The memory 620 may be electronic memories such as flash memory, EEPROM (Electrically Erasable Programmable Read-Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the server as shown in FIG. 6. The program codes may be compressed for example in an appropriate form. Usually, the memory cell includes computer readable codes 631′ which can be read for example by processors 610. When these codes are operated on the server, the server may be caused to execute respective steps in the method as described above.

“One embodiment”, “embodiments” or “one or more embodiments” herein means that particular features, structures or characteristics described in combination with the embodiments are included at least one embodiment of the present invention. Furthermore, it is to be noted that the term “in one embodiment” herein does not necessarily refers to the same embodiment.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

It should be noted that the above-described embodiments are intended to illustrate but not to limit the present invention, and alternative embodiments can be devised by a person skilled in the art without departing from the scope of claims as appended. In the claims, no reference mark between round brackets shall impose restriction on the claims. The word “include/comprise” does not exclude a component or step not listed in the claims. The wording “a” or “an” in front of an element does not exclude the presence of a plurality of such elements. The present invention may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be construed as naming.

Also, it should be noticed that the language used in the present specification is chosen for the purpose of readability and teaching, rather than explaining or defining the subject matter of the present invention. Therefore, it is apparent to an ordinary skilled person in the art that modifications and variations could be made without departing from the scope and spirit of the claims as appended. For the scope of the present invention, the publication of the present invention is illustrative rather than restrictive, and the scope of the present invention is defined by the appended claims.

1. A search method, comprising:
receiving, at a browser side, a search keyword inputted to an input box component;
obtaining a search result corresponding to the search keyword, the search result comprising feature information carrying a feature identifier; and
displaying the search result, wherein the feature information carrying a feature identifier is ranked first in the search result.

2. The method according to claim 1, wherein the feature information carrying a feature identifier has portal information of a preassociated webpage type service, and the method further comprises:
displaying a service page corresponding to the portal information when receiving a trigger operation for the feature information.

3. (canceled)

4. The method according to claim 2, wherein the step of obtaining a search result corresponding to the search keyword comprises:
searching for the search result corresponding to the search keyword from a local database of the browser, and executing the step of displaying the search result when the search result comprises the feature information carrying a feature identifier.

5. The method according to claim 4, wherein the step of obtaining a search result corresponding to the search keyword further comprises:
generating a search request in accordance with the search keyword and submitting the search request to a server when the search result in the local database does not comprise the feature information carrying a feature identifier; and
receiving the feature information carrying a feature identifier, returned by the server, corresponding to the search request, wherein the feature information returned by the server is obtained by searching the search keyword out from a database of the server after the server has received the search request.

6. (canceled)

7. The method according to claim 1, wherein the feature information comprises a telephone number, and the method further comprises:
saving the telephone number carrying a feature identifier in a contact list application.

8. The method according to claim 7, further comprising:
receiving a push message sent by a webpage type service corresponding to the telephone number carrying a feature identifier.

9. The method according to claim 2, wherein the feature information comprises a telephone number, and the method further comprises:
generating a dialing command when detecting a click operation for the telephone number, and sending the dialing command to a server, so that the server initiates a voice call request based on the telephone number to a communication operator in accordance with the dialing command;
and/or
displaying a message editing page when detecting the click operation for the telephone number, and sending a communication message to a terminal device corresponding to the telephone number when detecting the communication message inputted for the message editing page.

10. The method according to claim 9, further comprising:
when receiving dialing failure information returned by the server, invoking the portal information of the webpage type service based on the dialing failure information, and displaying a corresponding webpage type service page.

11. The method according to claim 1, wherein the step of obtaining a search result corresponding to the search keyword comprises:
obtaining current location information of a user; and
obtaining, based on the current location information, the search result corresponding to the search keyword and associated with the current location information.

12. A search apparatus, comprising:
a memory having instructions stored thereon;
a processor configured to execute the instructions to perform operations comprising:
receiving, at a browser side, a search keyword inputted to an input box component;
obtaining a search result corresponding to the search keyword, the search result comprising feature information carrying a feature identifier; and
displaying the search result, wherein the feature information carrying a feature identifier is ranked first in the search result.

13. The apparatus according to claim 12, wherein the feature information carrying a feature identifier has portal information of a preassociated webpage type service, and the operations further comprise:
displaying a service page corresponding to the portal information when receiving a trigger operation for the feature information.

14. (canceled)

15. The apparatus according to claim 13, wherein the operation of obtaining a search result corresponding to the search keyword, the search result comprising feature information carrying a feature identifier further comprises:
searching for the search result corresponding to the search keyword from a local database of the browser, and executing the operation of displaying the search result when the search result comprises the feature information carrying a feature identifier.

16. The apparatus according to claim 15, wherein the operation of searching for the search result corresponding to the search keyword from a local database of the browser, and executing the operation of displaying the search result when the search result comprises the feature information carrying a feature identifier further comprises:
generating a search request in accordance with the search keyword and submit the search request to a server when the search result in the local database does not comprise the feature information carrying a feature identifier; and
receiving the feature information carrying a feature identifier, returned by the server, corresponding to the search request, wherein the feature information returned by the server is obtained by searching the search keyword out from a database of the server after the server has received the search request.

17. (canceled)

18. The apparatus according to claim 12, wherein the feature information comprises a telephone number, and the operations further comprise:
saving the telephone number carrying a feature identifier in a contact list application.

19. The apparatus according to claim 18, wherein the operations further comprise:
receiving a push message sent by a webpage type service corresponding to the telephone number carrying a feature identifier.

20. The apparatus according to claim 13, wherein the feature information comprises a telephone number, and the operations further comprise:
generating a dialing command when detecting a click operation for the telephone number, and send the dialing command to a server, so that the server initiates a voice call request based on the telephone number to a communication operator in accordance with the dialing command; and
displaying a message editing page when detecting the click operation for the telephone number, and send a communication message to a terminal device corresponding to the telephone number when detecting the communication message inputted for the message editing page.

21. The apparatus according to claim 20, wherein the operations further comprise:
invoking, when receiving dialing failure information returned by the server, the portal information of the webpage type service based on the dialing failure information, and displaying a corresponding webpage type service page.

22. The apparatus according to claim 12, wherein the operation of obtaining a search result corresponding to the search keyword, the search result comprising feature information carrying a feature identifier further comprises:
obtaining current location information of a user; and
obtaining, based on the current location information, the search result corresponding to the search keyword and associated with the current location information.

23. (canceled)

24. A non-transitory computer-readable medium having computer programs stored thereon that, when executed by one or more processors of an electronic device, cause the electronic device to perform operations comprising:
receiving, at a browser side, a search keyword inputted to an input box component;
obtaining a search result corresponding to the search keyword, the search result comprising feature information carrying a feature identifier; and
displaying the search result, wherein the feature information carrying a feature identifier is ranked first in the search result.
